(19) United States
(12) Patent Application Publication
(10) Pub. No.: US 2011/0185012 A1
(43) Pub. Date: Jul. 28, 2011

(54) SYSTEM AND METHOD FOR GENERATING A NOTIFICATION MAILING LIST

(76) Inventor: Matthew D. Colley, Greenwood, IN (US)

(21) Appl. No.: 12/695,034

(22) Filed: Jan. 27, 2010

(51) Int. Cl. G06F 15/16

(52) U.S. Cl. 709/203

(57) ABSTRACT

A system, device, and method for generating a notification mailing list includes communicating with a client computing device to display a digital map on the client computing device. The digital map may include indicia of an area of coverage of one or more advertisements, indicia of the location of one or more excavators, indicia of the location(s) at which an underground utility was damaged due to excavation, and/or indicia of the location(s) a non-native speaking resident. A user of the client computing device may select an area of the digital map based on the indicia displayed on the digital map. A notification mailing list including the street mailing address of excavators located within the selected area is generated.

### TECHNICAL FIELD

The present disclosure relates generally to systems and methods for generating a notification mailing list and, more particularly, to systems and methods for generating a notification mailing list based on a digital map of a region of interest.

### BACKGROUND

Utility companies, such as electric, gas, water, and communication companies, own and maintain underground utilities. Such underground utilities include, for example, gas pipes, water conduits, electrical and communication wires, and the like. To provide utility service to end consumers, the underground utilities may cross public and private properties. However, because the utilities are disposed underground, the property owner and/or excavator planning to dig on the property may be unaware of the presence of the underground utility based on a simple visual inspection of the property. Excavating without knowledge of the location of underground utilities can result in severe damage to the underground utility and poses significant danger to the excavator, land owner, utility company, and surrounding community.

To combat the dangers of underground utilities, the underground utility companies participate in advertisement campaigns to inform company and residential excavators of the importance of notifying the utility companies prior to initiation of any excavation. Once notified, the utility companies identify and mark the underground utilities in the vicinity of the planned excavation so that the underground utility lines may be avoided. However, traditional advertisement media, such as radio, television, and print media, may not sufficiently reach all of the identified excavators in a particular region. Additionally, some regions may have an increased utility damage rate compared to other similar regions. In such situations, the underground utility companies may desire to augment the traditional advertisement campaign with supplemental notifications to the excavators in the identified regions.

### SUMMARY

According to one aspect, a server computing device may include a processor and a memory device. The memory device may have stored therein a plurality of instructions, which when executed by the processor, cause the server computing device to communicate with a client computing device to display a digital map of a region of interest on the client computing device. The plurality of instructions may also cause the server computing device to receive selected area data indicative of a selected area of the digital map from the client computing device. Additionally, the plurality of instructions may also cause the server computing device to determine the street mailing address of at least one excavator located within the selected area and generate a mailing list including the street mailing address of the at least one excavator.

In some embodiments, the plurality of instructions further cause the server computing device to communicate with the client computing device to display indicia of an area of coverage of an advertisement on the digital map. Additionally, the plurality of instructions further cause the server computing device to communicate with the client computing device to display indicia of a location of at least one excavator on the digital map. The plurality of instructions may also cause the server computing device to communicate with the client computing device to display indicia of a location at which an underground utility was damaged due to excavation. Additionally, the plurality of instructions may cause the server computing device to communicate with the client computing device to display indicia of a location a non-native speaking resident.

In some embodiments, the plurality of instructions may further cause the server computing device to retrieve census data from a public census database and communicate with the client computing device to display indicia of a location a non-native speaking resident based on the census data. Additionally, in some embodiments, the digital map may include indicia of an area of coverage of an advertisement, indicia of a location of at least one excavator on the digital map, and indicia of a location at which an underground utility was damaged due to excavation. Further, in some embodiments, the digital map includes indicia of an area of coverage of an advertisement and the selected area of the digital map does not overlap the area of coverage of the advertisement. Additionally or alternatively, in some embodiments, the digital map includes indicia of a location at which an underground utility was damaged due to excavation and the selected area of the digital map includes the location at which an underground utility was damaged.

Additionally, in some embodiments, the plurality of instructions further cause the server computing device to communicate with the client computing device to display an adjustable area selection tool on the digital map to generate the selected area. Further, in some embodiments, the plurality of instructions may cause the server computing device to communicate with the client computing device over a network.

According to another aspect, a method for generating a notification mailing list may include communicating with a client computing device to display a digital map on the client computing device. The method may also include receiving first selection data from the client computing device and communicating with the client computing device to display on the digital map, in response to the first selection data, at least one of: indicia of an area of coverage of an advertisement, indicia of a location of at least one excavator on the digital map, and indicia of a location at which an underground utility was damaged due to excavation. Additionally, the method may include receiving second selection data from the client computing device, the second selection data being indicative of a selected area of the digital map. The method may also include accessing an address database to determine the street mailing address of at least one excavator located within the selected area and generating a mailing list including the street mailing address of the at least one excavator.

In some embodiments, the method may further include retrieving census data form a public census database. In such embodiments, the method may also include displaying on the digital map indicia of a location a non-native speaking resident based on the census data. In some embodiments, receiving the second selection data may include receiving second selection data indicative of a selected area of the digital map that does not include the area of coverage of the advertisement. Additionally, in some embodiments, receiving the second selection data may include receiving second selection data indicative of a selected area of the digital map that includes the location at which the underground utility was damaged. Further, in some embodiments, the method may include transmitting the mailing list to the client computing device. Additionally, in some embodiments, the second selection data may identify a plurality of excavators located in the selected area.

According to a further aspect, a tangible, machine readable medium may include a plurality of instructions, which in response to being executed, result in a computing device displaying a digital map of a region of interest. The plurality of instructions may further result in the computing device displaying on the digital map, in response to a first selection, at least one of: indicia of an area of coverage of an advertisement, indicia of a location of at least one excavator, and indicia of a location at which an underground utility was damaged due to excavation. Additionally, the plurality of instructions may result in the computing device displaying, in response to a second selection, indicia of a user-selected area on the digital map and determining selected area data that identifies at least one excavator located within the user-selected area. Further, the plurality of instructions may result in the computing device transmitting the selected area data to a remote server computing device and receiving a mailing list including a street mailing address of the at least one excavator from the remote server computing device in response to transmitting the select area data. In some embodiments, the plurality of instructions further result in the computing device displaying, on the digital map, indicia of a location a non-native speaking resident. Additionally, in some embodiments, the user selected area may not overlap the area of coverage of the advertisement and may include the location at which the underground utility was damaged.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of one embodiment of a system for generating a notification mailing list;

FIG. 2 is a simplified flowchart of one embodiment of a method for generating a notification mailing list;

FIG. 3 is a simplified flowchart of another embodiment of a method for generating an notification mailing list; and

FIGS. 4-11 are illustrative screen displays that are displayed on a computing device of the system of FIG. 1 during the execution of the methods of FIG. 2 and/or 3.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, microcode, Central Processing Unit (CPU) instructions, software, or any combination thereof. Embodiments of the disclosure implemented in a computer system may include one or more bus-based interconnects between components and/or one or more point-to-point interconnects between components. Embodiments of the invention may also be implemented as instructions stored on a machine-readable, tangible medium, which may be read and executed by one or more processors. A machine-readable, tangible medium may include any tangible mechanism for storing or transmitting information in a form readable by a machine (e.g., a computing device). For example, a machine-readable, tangible medium may include read only memory (ROM); random access memory (RAM); magnetic disk storage media; optical storage media; flash memory devices; and other tangible mediums.

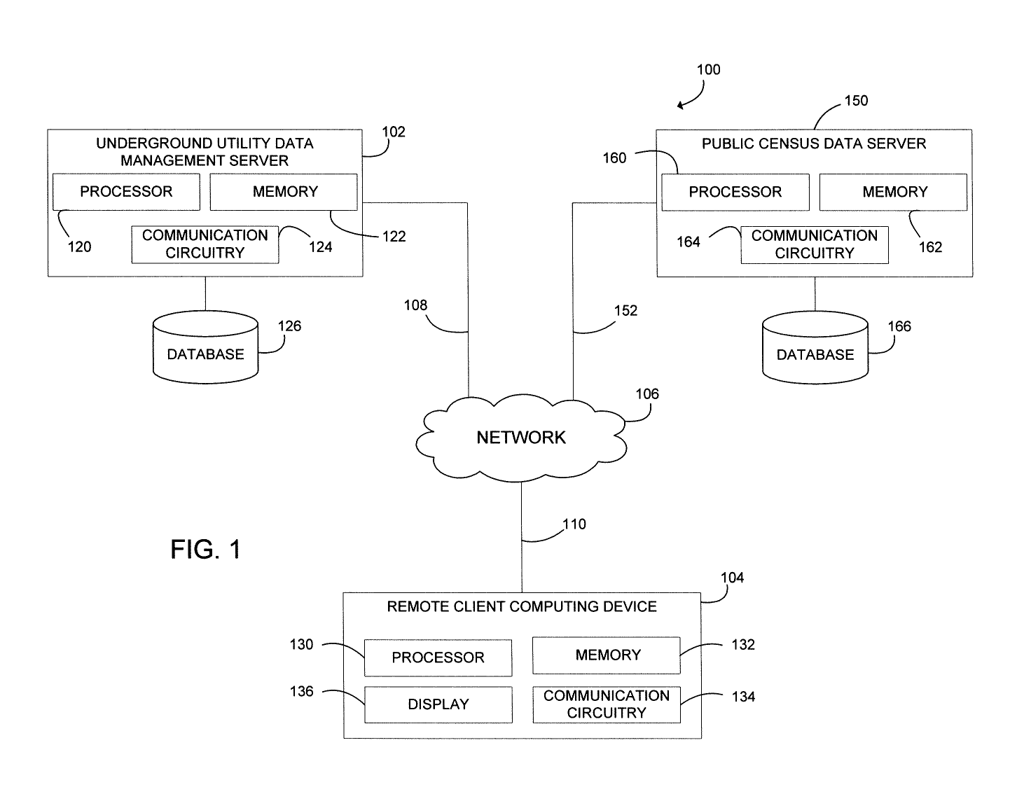

Referring now to FIG. 1, a system 100 for generating a notification mailing list includes an underground utility data management server 102, a remote client computing device 104, and a network 106. The underground utility data management server 102 and the remote client computing device 104 are configured to communicate with each other over the network 106. To facilitate such communication, the underground utility data management server 102 is communicatively coupled to the network 106 via a communication path 108. Similarly, the remote client computing device 104 is communicatively coupled to the network 106 via a communication path 110. Each of the communication paths 108, 110 may be embodied as any number of wires, cables, and/or devices (e.g., network gateway computers) capable of facilitating data communication between the underground utility data management server 102 and the network 106 and between the remote client computing device 104 and the network 106, respectively.

The underground utility data management server 102 may be embodied as one or more server computing devices configured to communicate with the remote client computing device 104 to display a digital map on the client computing device 104 and generate a notification mailing list based on selections made on the digital map as discussed in more detail below. The server 102 illustratively includes a processor 120, a memory device 122, and communication circuitry 124. The processor 120 may be embodied as any type of processor capable of performing the functions described herein. Illustratively, the processor 120 is embodied as a single core processor. However, in other embodiments, the processor 120 may be embodied as a multi-core processor having multiple processor cores. Additionally, the underground utility data management server 102 may include additional processors 120 having one or more processor cores in other embodiments.

The memory device 122 may be embodied as one or more memory devices or data storage locations including, for example, dynamic random access memory devices (DRAM), synchronous dynamic random access memory devices (SDRAM), double-data rate dynamic random access memory device (DDR SDRAM), and/or other volatile memory devices. Although only a single memory device 122 is illustrated in FIG. 1, in other embodiments, the underground utility data management server 102 may include additional memory devices.

The communication circuitry 124 may be embodied as any number of devices and circuitry for enabling communications between the underground utility data management server 102 and remote computing devices, such as the remote client computing device 104. For example, the communication circuitry 124 may include one or more wired or wireless network interfaces to facilitate wired or wireless communications over the network 106.

In some embodiments, the underground utility data management server 102 may also include, or otherwise be communicatively coupled to, a mailing address database 126. The database 126 may be embodied as any type of database for storing street mailing addresses of commercial or residential excavators as discussed in more detail below. For example, the database 126 may be embodied as stand-alone computing device separate from the data management server 102, as a storage device such as a hard drive or memory device incorporated in or separate from the data management server 102, one or more files, memory locations, or other data structures, which may be incorporated in, stored in, or otherwise associated with the data management server 102. Additionally, although only a single database 126 is illustrated in FIG. 1, it should be appreciated that the underground utility data management server 102 may include any number of databases 126 in other embodiments. Additionally, the underground utility data management server 102 may include other devices and peripherals such as those found in a typical server or computer including, but not limited to, a display device, input/output peripherals, and/or the like.

The remote client computing device 104 may be embodied as any type of computer or computing device capable of communicating with the underground utility data management server 102 over the network 106. For example, the client computing device 104 may be embodied as a desktop computer, mobile or laptop computer, a hand-held computing device such as personal data assistants, a mobile Internet device (MID), or a cellular phone, or other network-enabled computing device. The illustrative remote client computing device 104 includes a processor 130, a memory device 132, communication circuitry 134, and a display 136. However, the remote client computing device 104 may include other devices and peripherals such as those found in a typical client computing device including, but not limited to additional input/output peripherals, power circuitry, and/or the like.

The processor 130 may be embodied as any type of processor capable of performing the functions described herein. Similar to the processor 120 of the underground utility data management server 102, the processor 130 may be embodied as a single or multi-core processor. Additionally, in some embodiments, the remote client computing device 104 may include additional processors 130 having one or more processor cores. The memory device 132 may be embodied as one or more memory devices or data storage locations including, for example, dynamic random access memory devices (DRAM), synchronous dynamic random access memory devices (SDRAM), double-data rate dynamic random access memory device (DDR SDRAM), and/or other volatile memory devices. The communication circuitry 134 may be embodied as any number of devices and circuitry for enabling communications between the remote computing device 104 and the underground utility data management server 102 such as, for example, one or more wired or wireless network interfaces to facilitate wired or wireless communications over the network 106. The display 136 may be embodied as any type of display device capable of displaying data to a user of the client computing device 104. For example, the display device 136 may be embodied as a liquid crystal display (LCD), a light emitting diode (LED) display, a plasma display, or other display screen or device.

The network 106 may be embodied as any type of wired and/or wireless network such as a local area network, a wide area network, a publicly available global network (e.g., the Internet), or other network. Additionally, the network 106 may include any number of additional devices to facilitate the communication between the underground utility data management server, the remote client computing device 104, and other computing devices such as routers, switches, intervening computers, and the like.

In some embodiments, the system 100 may also include a public census data server 150. The public census data server 150 is located remotely from the underground utility data management server 102 and communicatively coupled to the network 106 via a communication path 152. The communication path 152 may be embodied as any number of wires, cables, and/or devices (e.g., network gateway computers) capable of facilitating data communication between the public census data server 150 and other remote computing devices, such as the underground utility data management server 102. The public census data server 150 stores public census data that is accessible by the general public. Such public census data may include, for example, data indicating whether a resident is native or non-native speaking. As discussed in more detail below, the census data may be used to determine whether additional notifications should be mailed to company and residential excavators located in a particular area and, more particularly, whether such notifications should include notifications written in another language.

In the illustrative embodiments, the public census data server 150 includes a processor 160, a memory device 162, and communication circuitry 164. The processor 160 may be embodied as any type of processor capable of performing the functions described herein. Similar to the processor 120 of the underground utility data management server 102, the processor 160 may be embodied as a single or multi-core processor. The memory device 162 may be embodied as one or more memory devices or data storage locations including, for example, dynamic random access memory devices (DRAM), synchronous dynamic random access memory devices (SDRAM), double-data rate dynamic random access memory device (DDR SDRAM), and/or other volatile memory devices. The communication circuitry 164 may be embodied as any number of devices and circuitry for enabling communications between the public census data server 150 and the underground utility data management server 102 such as, for example, one or more wired or wireless network interfaces to facilitate wired or wireless communications over the network 106.

In some embodiments, the public census data server 150 may also include, or otherwise be communicatively coupled to, a census database 166. The database 166 may be embodied as any type of database for storing census data such as data indicating whether a resident is native or non-native speaking The database 166 may be embodied as stand-alone computing device separate from the public census data server 150, as a storage device such as a hard drive or memory device incorporated in or separate from the public census data server 150, one or more files, memory locations, or other data structures, which may be incorporated in, stored in, or otherwise associated with the public census data server 150. Additionally, although only a single database 166 is illustrated in FIG. 1, it should be appreciated that the public census data server 150 may include any number of databases 166 in other embodiments. Further, the public census data server 150 may include other devices and peripherals such as those found in a typical server or computer including, but not limited to, a display device, input/output peripherals, and/or the like.

In use, the remote client computing device 104 may be operated by a user, such as a utility company, to communicate with the underground utility data management server 102 to generate a notification mailing list. To do so, the underground utility data management server 102 is configured to communicate with the client computing device 104 to display a digital map of a region of interest on computing device 104 (i.e., on the display 136). The user may select an area of the digital map from which the mailing list is to be generated. In response to the selected area, the underground utility data management server 102 is configured to determine the street mailing address of excavators located in the selected region. Such excavators may be embodied as any company, person, or other entity known to or likely to participate in excavating activities such as digging. In some embodiments, the excavating entities pre-register with the underground utility data management server 102 and/or are determined based on past excavation activities.

Based on the selected area, the underground utility data management server 102 is configured to generate a mailing list including the street mailing address of those excavators located in the selected area of the digital map. The user (e.g., utility company) may use the mailing list to provide additional or supplemental notifications to the identified excavators regarding, for example, the importance of notifying the utility company or call center prior to digging. As discussed in more detail below, the selected area may be selected by the user based on one or more criteria such as the coverage area of one or more advertisements or advertisement campaigns, the location of past underground utility damage, the location of non-native speaking residents, and/or other data or criteria.

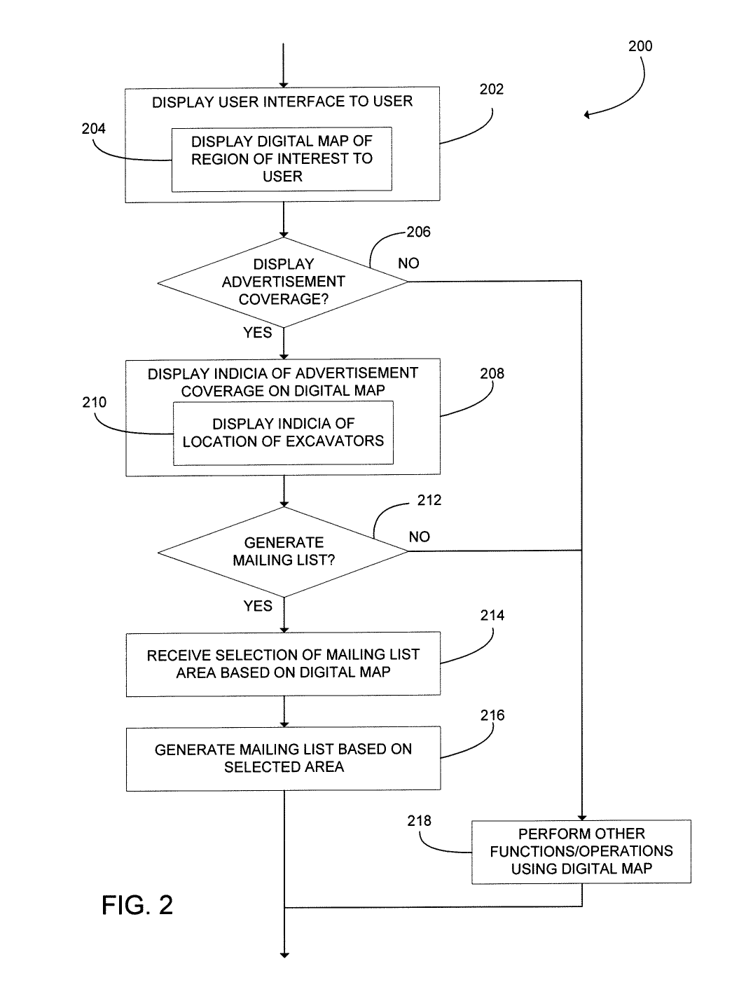

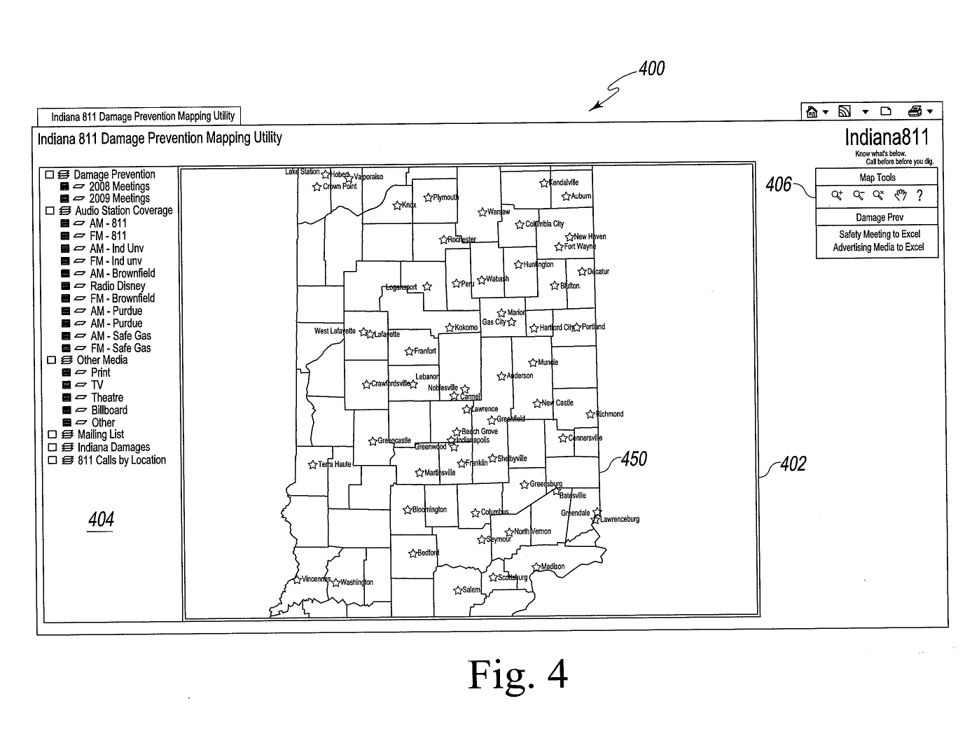

Referring now to FIG. 2, in one embodiment, the system 100 may execute a method 200 for generating a notification mailing list. The method 200 begins with block 202 in which a user interface 400 (see FIG. 4) is displayed on the remote client computing device 104. To do so, the underground utility data management server 102 and the remote client computing device 104 may communicate with each other in block 202. For example, a user may operate the remote client computing device 104 to access a website or other portal operated by the underground utility data management server 102. In response, the server 102 may transmit the user interface 400 to the remote client computing device 104 for display thereon.

As illustrated in FIG. 4, the illustrative user interface 400 includes a map window 402 in which a digital map of a region of interest may be displayed, a data window 404 in which various data display options may be selected by the user, and a tool bar 406 from which various tools may be selected by the user. As discussed in more detail below, a user may select one or more of the data display options from the data window 404 to cause indicia of the selected data (e.g., advertisement coverage) to be displayed on the digital map shown in the map window 402. Additionally, the user may select one or more of the tools from the tool bar 406 to interact with the digital map such as, for example, zooming in on the digital map, zooming out of the digital map, moving the digital map, selecting areas on the digital map, and requesting help with the user interface 400.

Referring back to FIG. 2, in block 204, the underground utility data management server 102 communicates with the remote client computing device 104 to display a digital map 450 (see FIG. 4) in the map window 402 of the user interface 400. As discussed above, the user may manipulate the displayed digital map 450 using one or more of the tools from the tool bar 406.

In block 206, the system 100 determines whether the user has chosen to display advertisement coverage on the digital map 450. To do so, the user may select one or more data display options from the data window 404 to cause indicia of the corresponding advertisement coverage to be displayed on the digital map 450. Such advertisement coverage may be indicative of the coverage of one or more advertisements that are configured to notify excavators of the importance of notifying the utility company(s) of planned excavation prior to initiating the excavation activity. However, the advertisement coverage may not cover the entirety of the digital map 450. The user may select any number of advertisement sources (e.g., radio stations) or advertisement media (radio, print, direct mailings, etc) from the data window 404 to be displayed on the digital map 450.

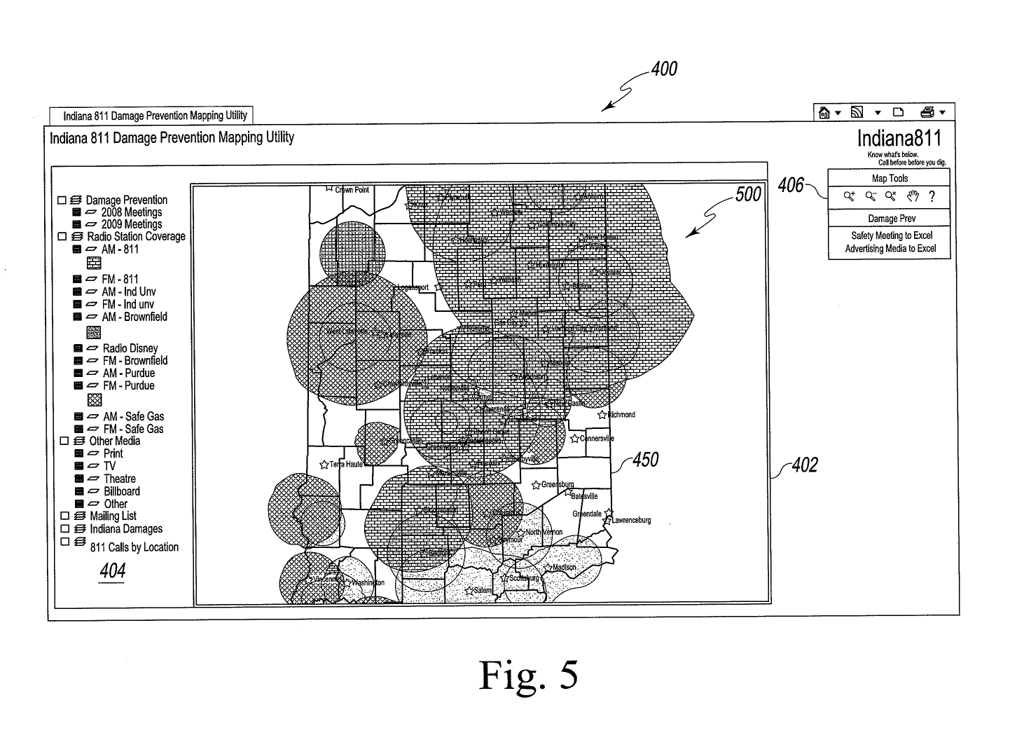

If the system 100 determines that the user has not chosen to display advertisement coverage in block 206, the method 200 advances to block 218 in which other functions or operations using the digital map may be performed as discussed in more detail below. However, if the system 100 determines that the user has chosen to display advertisement coverage, the method 200 advances to block 208 in which indicia of the area of coverage of the selected advertisement sources and/or media is displayed on the digital map 450. For example, as illustrated in FIG. 5, indicia 500 of the area of coverage of one or more advertisements (i.e., advertisement sources and/or media) may be displayed on the digital map 450. In the illustrative embodiment of FIG. 5, the indicia 500 is embodied as geometrical shapes (e.g., circles and polygons) corresponding to the signal coverage of radio stations on which advertisements regarding the importance of notifying the utility company(s) of planned excavation prior to initiating the excavation activity are aired. However, indicia of the area of coverage of other advertisements sources may be displayed on the digital map 450 in other embodiments based on, for example, the particular data display options selected by the user form the data display window 404.

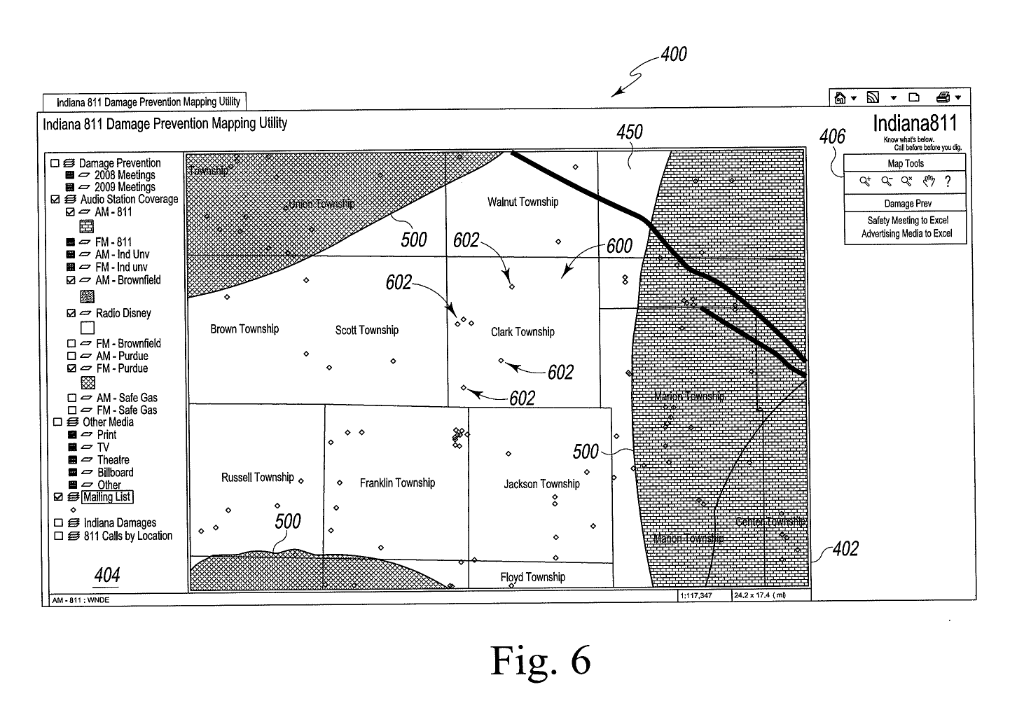

As can be readily seen in FIG. 5, some areas of the digital map 450 are covered by multiple indicia 500 of areas of advertisement coverage, while other areas of the digital map 450 are not covered by any indicia 500. As such, excavators located within those areas not covered by any advertisement indicia 500 may not receive sufficient notification regarding the importance of notifying the underground utility company prior to excavating. The user may zoom in on the regions lacking adequate advertisement coverage via use of a zoom tool selected from the tool bar 406. For example, as illustrated in FIG. 6, an illustrative area 600 corresponding to “Clark Township” is not covered by any of the surrounding indicia 500 of the area of coverage of the selected advertisements. As such, excavators located in the “Clark Township” area 600 may not be properly notified of the importance to contact the underground utility company prior to excavation.

Referring back to FIG. 2, in order to visualize those excavators not adequately covered by the selected advertisements, indicia 602 of the location of the excavators may be displayed on the digital map 450 in block 210. To do so, the user may select the appropriate data display option from the data display window 404 to cause the indicia 602 to be displayed on the digital map 450. In response, the underground utility data management server 102 may retrieve excavator location data from the database 126 and communicate such data to the client computing device 104 for display on the digital map 450. As shown in FIG. 6, the indicia 602 of the location of excavators may be embodied as any suitable indicia such as geometric shapes of various colors.

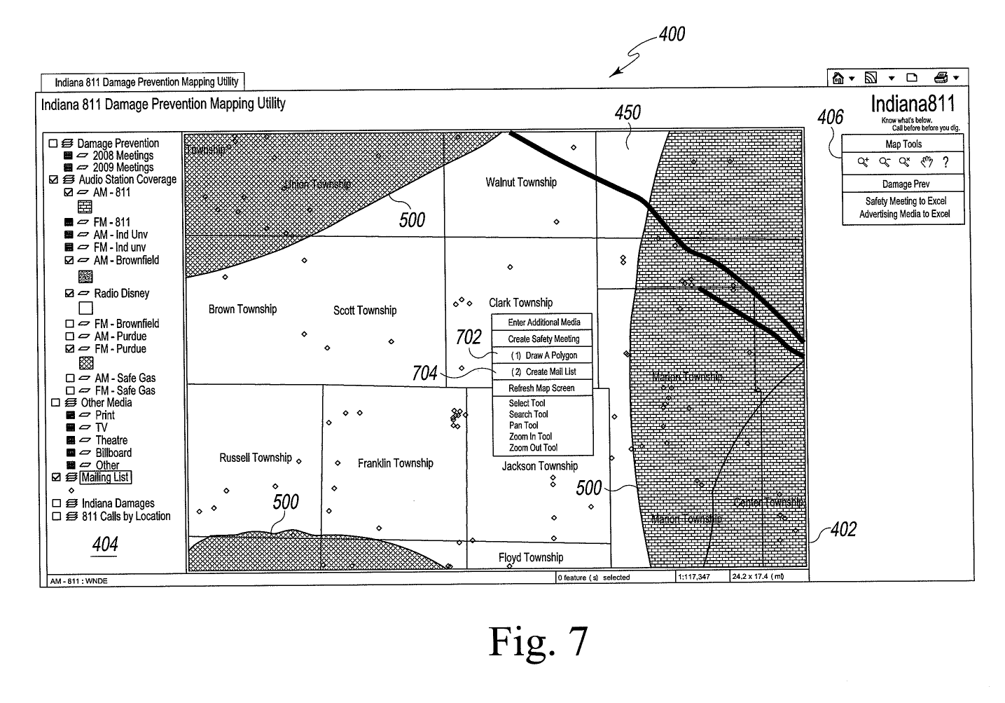

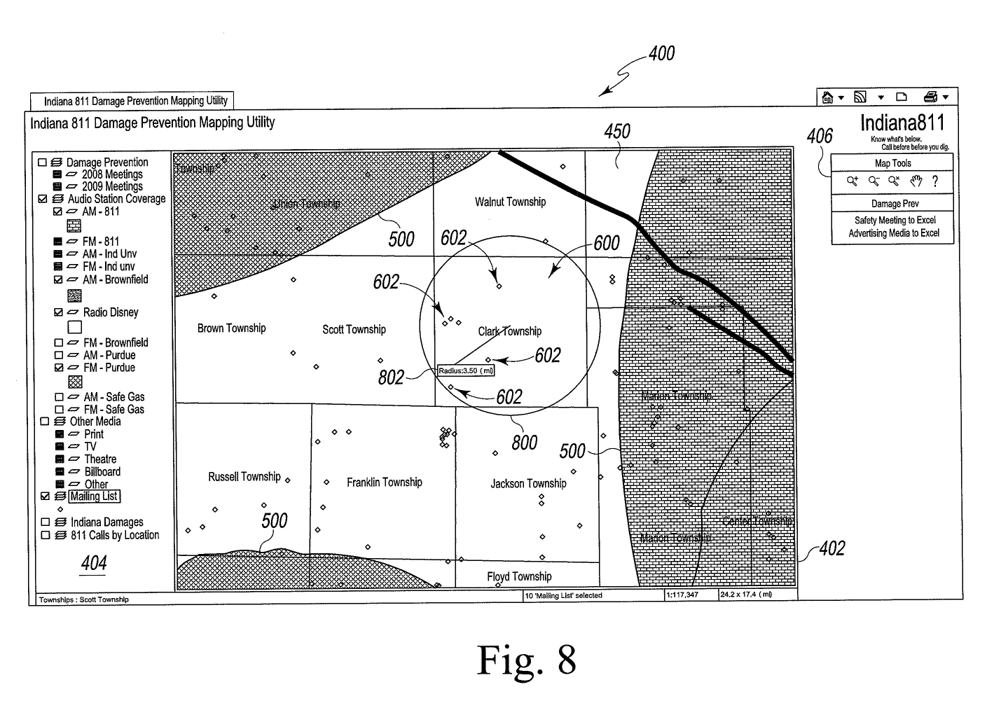

In block 212, the system 100 determines whether the user of the client computing device 104 desires to generate a notification mailing list based on the digital map 450. If not, the method 200 advances to block 218 in which other functions or operations using the digital map 450 may be performed as discussed in more detail below. However, if the user desires to generate a mailing list, the user may select an area of the digital map 450 on which the mailing list is to be based in block 212. For example, as shown in FIG. 7, if the user desires to select the area 600 corresponding to “Clark Township,” which is not adequately covered by any of the advertisement coverage indicia 500, the user may right-click on the digital map 450 to access an area selection menu 700. The user may subsequently select a “Create A Polygon” option 702 from the menu 700 to select an area of the digital map 450. As shown in FIG. 8, the user may create, size, and position a selection polygon or indicia 800 to cover the area 600 corresponding to “Clark Township.” If the user has selected to display the indicia 602 of the excavators located in the area 600, the user can ensure the selection polygon 800 covers the desired excavators 602. In some embodiments, a distance window 802 is also displayed to the user to notify the user of the amount of coverage (e.g., radius) of the selection polygon 800.

Once the user has selected the desired area of the digital map 450 using the selection polygon 800, those excavators 602 located in selected area may be highlighted on the digital map 450 (e.g., the color of the indicia 602 may be changed) or otherwise automatically selected based on the selection polygon 800. In this way, the user of the remote computing device 104 may select one or more excavators by selecting an area of the digital map 450. Because the indicia 500 of the area of coverage of the selected advertisements is also visible on the digital map 450, the user may select those areas of the digital map 450 lacking sufficient coverage by the advertisements. As such, the selected area and the indicia 500 of the area of coverage of the selected advertisements may or may not overlap.

Once the user has selected the desired area of the digital map 450, the user may select a “Create Mail List” option from the area selection menu 700. In response, selection data is transmitted from the remote computing device 104 to the underground utility data management server 102 in block 214 (see FIG. 2). In some embodiments, the selection data may be embodied as data indicative of the area of the digital map 450 selected by the user using the selection polygon 800. In such embodiments, the underground utility data management server 102 is configured to determine those excavators located within the selected area using the excavator data located in the database 126. In other embodiments, the selection data is indicative of those excavators located in the selected area. In such embodiments, the remote client computing device 104 may be configured to determine those excavators located within the selected area and transmit identification of those excavators to the underground utility data management server 102 in block 322.

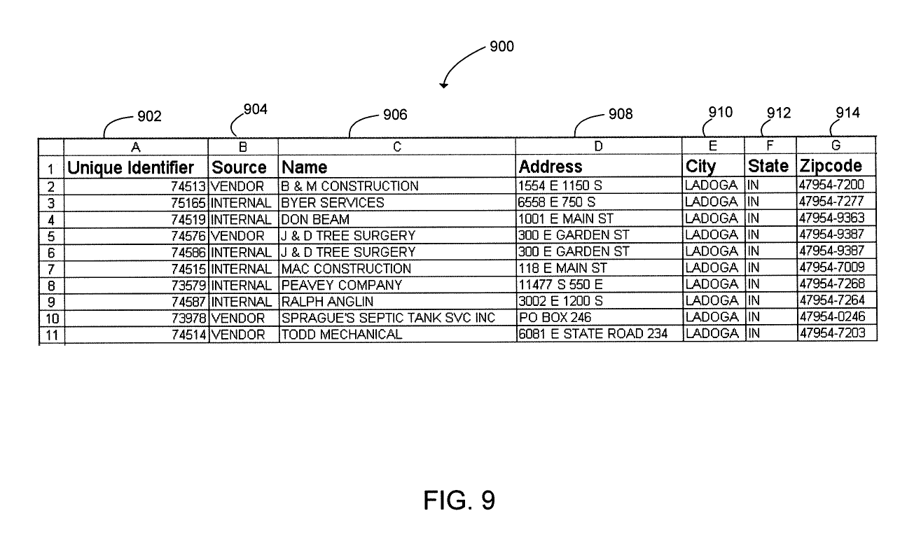

In block 216, the underground utility data management server 102 determines the street mailing address of those excavators located within the selected area and generates a mailing list 900 (see FIG. 9) including the street mailing address of the selected excavators. To do so, the underground utility data management server 102 may access the database 126 to retrieve the street mailing address of the selected excavators and transmit the mailing list to the remote client computing device 104 for display on the device 104. As shown in FIG. 9, the mailing list may include a unique identifier 902, a source indicator 904, a name 906 of the excavator, an address 908 of the excavator, a city 910 of the excavator, a state 912 of the excavator, and a zip code of 914 of the excavator. As such, the user (e.g., utility company) of the client computing device 104 may use the mailing list 900 to mail direct notifications to those excavators determined to be located in the selected area (e.g., an area not sufficiently covered by advertisements).

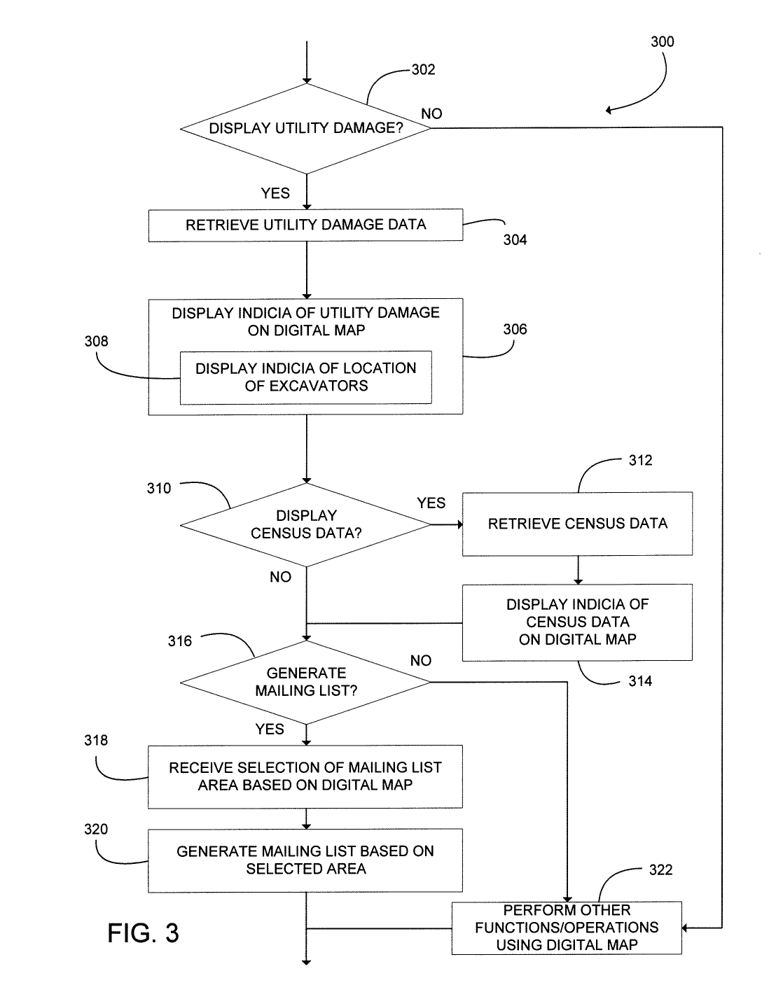

As discussed above, in some embodiments, additional functions and operations may be performed using the digital map 450 in block 218 of the method 200. For example, as illustrated in FIG. 3, a method 300 for generating a mailing list may be executed by the system 100 in block 218. The method 300 begins with block 302 in which the system 100 determines whether the user has chosen to display indicia of the location(s) at which damage to underground utilities has been reported. Such damage may be based on periodic reports, such as yearly reports of utility damage. If not, the method 300 advances to block 322 in which other functions or operations using the digital map 450 may be performed. However, if the user desires to view the location of reported utility damage, the method advances to block 304.

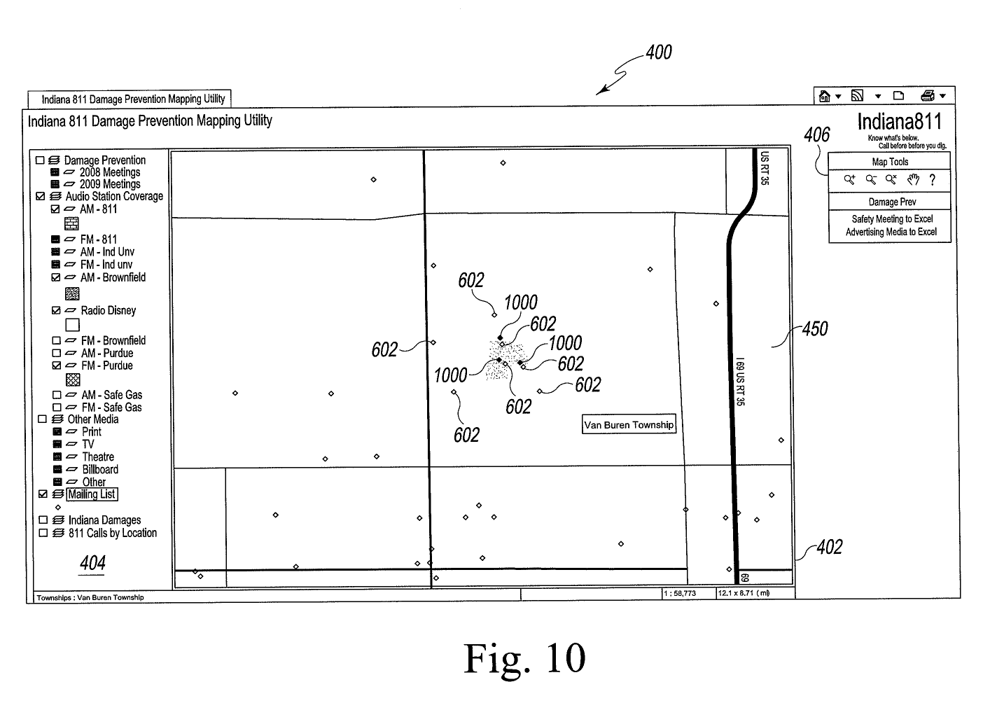

In block 304, the underground utility data management server 102 retrieves utility damage data from the database 126 and transmits data indicative of the location at which such damage occurred to the client computing device 104. In block 306, indicia 1000 of the location at which underground utility damage occurred is displayed on the digital map 450 on the client computing device 104. As shown in FIG. 10, the indicia 1000 may be embodied as any suitable geometric shape having any suitable color capable of identifying particular locations on the digital map 450 at which underground utility damage has occurred. In block 308, the indicia 602 of the location of known excavators may also be displayed on the digital map 450. In this way, the user may determine whether a particular area has a large number of damage incidents and, if so, select those excavators within the particular area to which to mail direct notifications reminding of the importance to contact the underground utility company prior to excavation.

Referring back to FIG. 3, in block 310, the system 100 determines whether the user has chosen to display census data on the digital map 450. To do so, the user may select the appropriate option from the data display window 404. In response, the method 300 advances to block 312 in which census data is retrieved. In some embodiments, the underground utility data management server 102 may be configured to access the public census data server 150 to retrieve the census data in block 312. Alternatively, in other embodiments, the underground utility data management server 102 may be configured to periodically communicate with the public census data server 150 to retrieve the census data and store the census data in the database 126. In such embodiments, the underground utility data management server 102 is configured to retrieve the census data form the database 126 in block 312. In the illustrative embodiment, the census data includes data indicative of the location of non-native speaking residents. However, in other embodiments, the census data may include additional or other data.

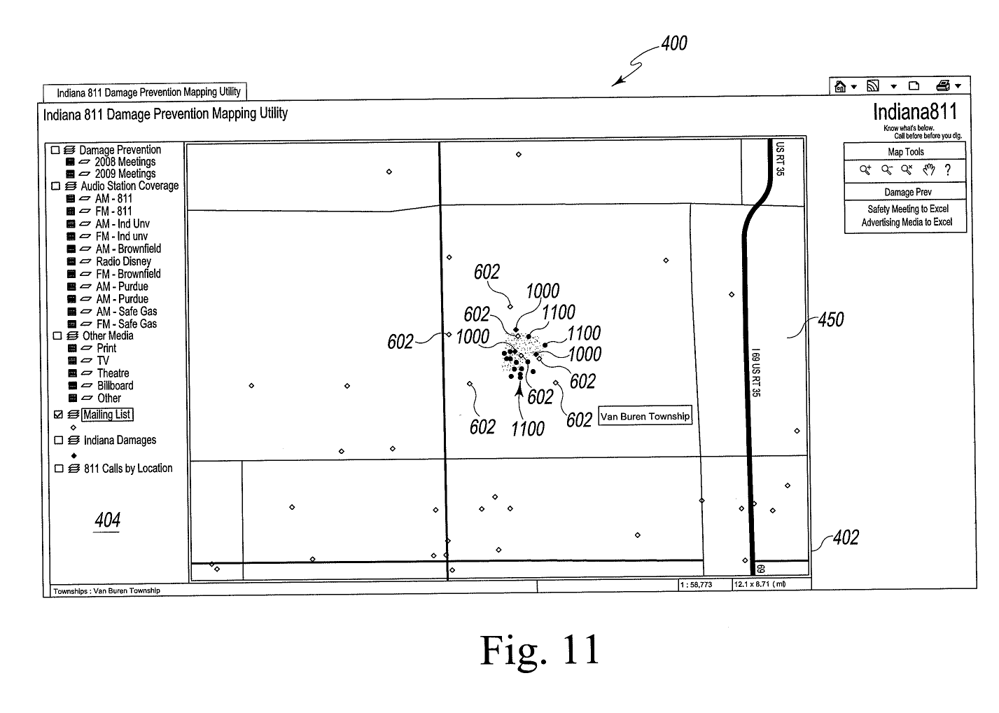

In block 314, the server 102 communicates with the client computing device 104 in block 314 to display indicia 1100 of the location of non-native speaking residents on the digital map 450 as shown in FIG. 11. The indicia 1100 may be embodied as any suitable geometric shape having any suitable color capable of identifying the location of non-native speaking residents. In this way, the user of the client computing device 104 may determine whether a particular area has a large number of non-native speaking residents and, if so, select those excavators within the particular area to which to mail direct notifications written in the appropriate language to remind those excavators of the importance to contact the underground utility company prior to excavation.

Subsequently, in block 316, the system 100 determines whether the user of the client computing device 104 desires to generate a notification mailing list based on the digital map 450. If not, the method 300 advances to block 322 in which other functions or operations using the digital map 450 may be performed. However, if the user desires to generate a mailing list, the user may select an area of the digital map 450 on which the mailing list is to be based in block 316 as discussed above in regard to block 212 of the method 200. The selected area may include the indicia 1000 of the location at which underground utility damage has occurred and/or the indicia 1100 of the location of non-native speaking residents as discussed.

Once the user has selected the desired area of the digital map 450 as discussed above in regard to the method 200, selection data is transmitted from the remote computing device 104 to the underground utility data management server 102 in block 318. As discussed above, the selection data may be embodied as data indicative of the area of the digital map 450 selected by the user using the selection polygon 800 and/or data indicative of those excavators located in the selected area. Subsequently in block 320, the underground utility data management server 102 determines the street mailing address of those excavators located within the selected area and generates a street mailing address list similar to the mailing list 900 described above and illustrated in FIG. 9. As such, the user (e.g., utility company) of the client computing device 104 may use the generated mailing list to mail direct notifications to those excavators determined to be located in the selected area (e.g., an area having an increased incidence of utility damage and/or a larger population of non-native speaking residents).

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

1. A server computing device comprising:
a processor; and
a memory device having stored therein a plurality of instructions, which when executed by the processor, cause the server computing device to:
communicate with a client computing device to display a digital map of a region of interest on the client computing device;
receive selected area data indicative of a selected area of the digital map from the client computing device;
determine the street mailing address of at least one excavator located within the selected area; and
generate a mailing list including the street mailing address of the at least one excavator.

2. The server computing device of claim 1, wherein the plurality of instructions further cause the server computing device to communicate with the client computing device to display indicia of an area of coverage of an advertisement on the digital map.

3. The server computing device of claim 1, wherein the plurality of instructions further cause the server computing device to communicate with the client computing device to display indicia of a location of at least one excavator on the digital map.

4. The server computing device of claim 1, wherein the plurality of instructions further cause the server computing device to communicate with the client computing device to display indicia of a location at which an underground utility was damaged due to excavation on the digital map.

5. The server computing device of claim 1, wherein the plurality of instructions further cause the server computing device to communicate with the client computing device to display indicia of a location a non-native speaking resident on the digital map.

6. The server computing device of claim 1, the plurality of instructions further cause the server computing device to:
retrieve census data from a public census database; and
communicate with the client computing device to display, on the digital map, indicia of a location a non-native speaking resident based on the census data.

7. The server computing device of claim 1, wherein the digital map includes indicia of an area of coverage of an advertisement, indicia of a location of at least one excavator on the digital map, and indicia of a location at which an underground utility was damaged due to excavation.

8. The server computing device of claim 1, wherein:
the digital map includes indicia of an area of coverage of an advertisement, and the selected area of the digital map does not overlap the area of coverage of the advertisement.

9. The server computing device of claim 1, wherein:
the digital map includes indicia of a location at which an underground utility was damaged due to excavation, and
the selected area of the digital map includes the location at which an underground utility was damaged.

10. The server computing device of claim 1, wherein the plurality of instructions further cause the server computing device to communicate with the client computing device to display an adjustable area selection tool on the digital map to generate the selected area.

11. The server computing device of claim 1, wherein to communicate with a client computing device comprises to communicate with the client computing device over a network.

12. A method for generating a notification mailing list, the method comprising:
communicating with a client computing device to display a digital map on the client computing device;
receiving first selection data from the client computing device;
communicating with the client computing device to display on the digital map, in response to the first selection data, at least one of: indicia of an area of coverage of an advertisement, indicia of a location of at least one excavator on the digital map, and indicia of a location at which an underground utility was damaged due to excavation;
receiving second selection data from the client computing device, the second selection data being indicative of a selected area of the digital map;
accessing an address database to determine the street mailing address of at least one excavator located within the selected area; and
generating a mailing list including the street mailing address of the at least one excavator.

13. The method of claim 12, further comprising:
retrieving census data form a public census database; and
displaying on the digital map indicia of a location a non-native speaking resident based on the census data.

14. The method of claim 12, wherein receiving second selection data comprises receiving second selection data indicative of a selected area of the digital map that does not include the area of coverage of the advertisement.

15. The method of claim 12, wherein receiving second selection data comprises receiving second selection data indicative of a selected area of the digital map that includes the location at which the underground utility was damaged.

16. The method of claim 12, further comprising transmitting the mailing list to the client computing device.

17. The method of claim 12, wherein receiving second selection data comprises receiving second selection data that identifies a plurality of excavators located in the selected area.

18. A tangible, machine readable medium comprising a plurality of instructions, that in response to being executed, result in a computing device:
displaying a digital map of a region of interest;
displaying on the digital map, in response to a first selection, at least one of:
indicia of an area of coverage of an advertisement, indicia of a location of at least one excavator, and indicia of a location at which an underground utility was damaged due to excavation;
displaying, in response to a second selection, indicia of a user-selected area on the digital map;
determining selected area data that identifies at least one excavator located within the user-selected area;
transmitting the selected area data to a remote server computing device; and
receiving a mailing list including a street mailing address of the at least one excavator from the remote server computing device in response to transmitting the select area data.

19. The tangible, machine readable medium of claim 18, wherein the plurality of instructions further result in the computing device:
displaying, on the digital map, indicia of a location a non-native speaking resident.

20. The tangible, machine readable medium of claim 18, wherein the user selected area (i) does not overlap the area of coverage of the advertisement and (ii) includes the location at which the underground utility was damaged.
